(19) United States
(12) Patent Application Publication
(10) Pub. No.: US 2017/0368978 A1
(43) Pub. Date: Dec. 28, 2017

(54) Device for Lifting the Bed of a Truck

(71) Applicant: TEC DESIGN, LLC, Fruit Heights, UT (US)

(72) Inventor: Paul Taylor, Fruit Heights, UT (US)

(73) Assignee: TEC DESIGN, LLC, Fruit Heights, UT (US)

(21) Appl. No.: 15/533,574

(22) PCT Filed: Dec. 10, 2015
(86) PCT No.: PCT/US15/65021

§ 371 Date: Jun. 6, 2017

(51) Int. Cl. B60P 1/28; B60S 11/00; B60P 1/48; B60P 1/54

(52) U.S. Cl. CPC B60P 1/283; B60S 11/00; B60P 1/483; B60P 1/5433

(57) ABSTRACT

A lifting device for lifting the bed of a truck comprises a bracket configured to be coupled to an undercarriage of the truck and a lifting mechanism coupled to the bracket. The lifting mechanism extends from the bracket to the underside of the bed and moves between a retracted position where the bed is supported by the undercarriage and an extended position where at least a portion of the bed is raised relative to the undercarriage.

### CROSS-REFERENCE TO RELATED PATENT APPLICATIONS

This claims the benefit of U.S. Provisional Pat. App. No. 62/090,206, titled “Device for Lifting the Bed of a Truck,” filed on 10 Dec. 2014, the entire contents of which are incorporated by reference into this document.

### BACKGROUND

There are a number of situations when it is necessary to access hard to reach areas under the bed of a truck. One such situation is when a mechanic needs to repair a fuel tank, change a fuel pump, replace a fuel level sensor, or perform other fuel system related maintenance.

The conventional method for such tasks is to remove the hard to reach components from under the bed. In the case of a fuel tank or fuel pump, this involves draining and removing the fuel tank. Removing the components is a major inconvenience. In the case of the fuel tank, draining and refilling the tank substantially increases the risk and complexity of the process. It would be helpful to find an easier, less risky way to access the area under the bed of a truck.

### DISCLOSURE OF THE INVENTION

A number of representative embodiments are described to illustrate the various features, characteristics, and advantages of the lifting device. The embodiments are provided in the context of repairing a truck. It should be understood, however, that many of the concepts may be used in a variety of other settings, situations, and configurations.

A lifting device can be used to lift one component of a vehicle relative to the frame of the vehicle (e.g., the bed of a truck) to provide access to hard to reach areas such as the fuel tank and/or fuel pump. The lifting device includes a bracket configured to be coupled to the undercarriage of the vehicle and a lifting mechanism coupled to the bracket. The lifting mechanism extends from the bracket to the underside of the component and moves between a retracted position where the component is supported by the undercarriage and an extended position where at least a portion of the component is raised relative to the undercarriage.

It should be appreciated that the lifting device can be used to lift any portion of the vehicle relative to the undercarriage of the vehicle. For example, the lifting device can be used to lift the bed of truck, the cab of a truck, the body of a car, the engine, and/or other components of the vehicle. In a preferred embodiment, the lifting device can be used to lift the bed of a truck.

The lifting device is a portable tool that a mechanic or other user can use to raise at least a portion of the bed of the truck to repair or otherwise access the area under the bed. The lifting device can be configured to work with a variety of trucks having a variety of beds. For example, the lifting device can be used with beds that include a flatbed, cargo box, or specialty body.

The lifting device can have any suitable configuration. In one embodiment, the bracket is configured to hang on a frame rail that extends parallel to a longitudinal axis of the truck. The lifting mechanism includes a fixed member and a movable member coupled to the fixed member. The fixed member is coupled to the bracket. The movable member extends outward from the fixed member as the lifting mechanism moves to an extended position and retracts toward the fixed member as the lifting mechanism moves to a retracted position. In one embodiment, the lifting mechanism is a hydraulic or screw lifting mechanism.

The lifting device can be coupled to the bed/truck in a readily removable manner. For example, the bracket can be coupled to the undercarriage of the truck without being fastened to the undercarriage with a fastener. The bracket is shaped to rest on the frame rail of the truck. Likewise, the lifting device can engage the underside of the bed without being fastened to the underside of the bed with a fastener.

The lifting device can be used in a variety of ways to raise the bed of the truck. In one embodiment, the bracket is coupled to the frame rail of the truck adjacent to the wheel well. The lifting mechanism is then attached to the bracket. The first end of the lifting mechanism is adjacent to and/or contacts the underside of a first side of the bed. The first side is parallel to a longitudinal direction of the truck. The bed includes a second side positioned opposite the first side and parallel to the longitudinal direction of the truck.

The fasteners holding the bed to the undercarriage are removed on the first side of the bed and the fasteners on the second side of the bed are loosened. Any electrical or other cables that would prevent the first side of the bed from being raised are disconnected—e.g., electrical cables to the rear lights on the first side of the bed. The lifting mechanism is extended to raise the bed on the first side. The bed is lowered by following the same procedure in reverse.

The Summary is provided to introduce a selection of concepts in a simplified form that are further described below in the Detailed Description. The Summary and the Background are not intended to identify key concepts or essential aspects of the disclosed subject matter, nor should they be used to constrict or limit the scope of the claims. For example, the scope of the claims should not be limited based on whether the recited subject matter includes any or all aspects noted in the Summary and/or addresses any of the issues noted in the Background.

### BRIEF DESCRIPTION OF THE DRAWINGS

The preferred and other embodiments are disclosed in association with the accompanying drawings in which:

FIG. 1 is a perspective view of one embodiment of a lifting device for lifting the bed of a truck. The lifting device includes a lifting mechanism and a bracket.

FIG. 2 is a perspective view of FIG. 1 showing the lifting mechanism and the bracket coupled together.

FIG. 3 is a perspective view of one embodiment of a truck with a bed that can be lifted by the lifting device in FIG. 1.

FIG. 4 is a perspective view of the truck in FIG. 3 with one side of the bed lifted by the lifting device in FIG. 1.

FIG. 5 is a perspective view of the bracket before it is coupled to the undercarriage of a truck.

FIG. 6 is a perspective view of the bracket coupled to the undercarriage of the truck.

FIG. 7 is a perspective view of the lifting mechanism coupled to the bracket so that the lifting device is positioned between the undercarriage of the truck and the underside of the bed. The lifting device is in a retracted position.

FIG. 8 is a perspective view of the lifting device in FIG. 7 in an extended position with the side of the truck bed raised.

### BEST MODE(S) FOR CARRYING OUT THE INVENTION

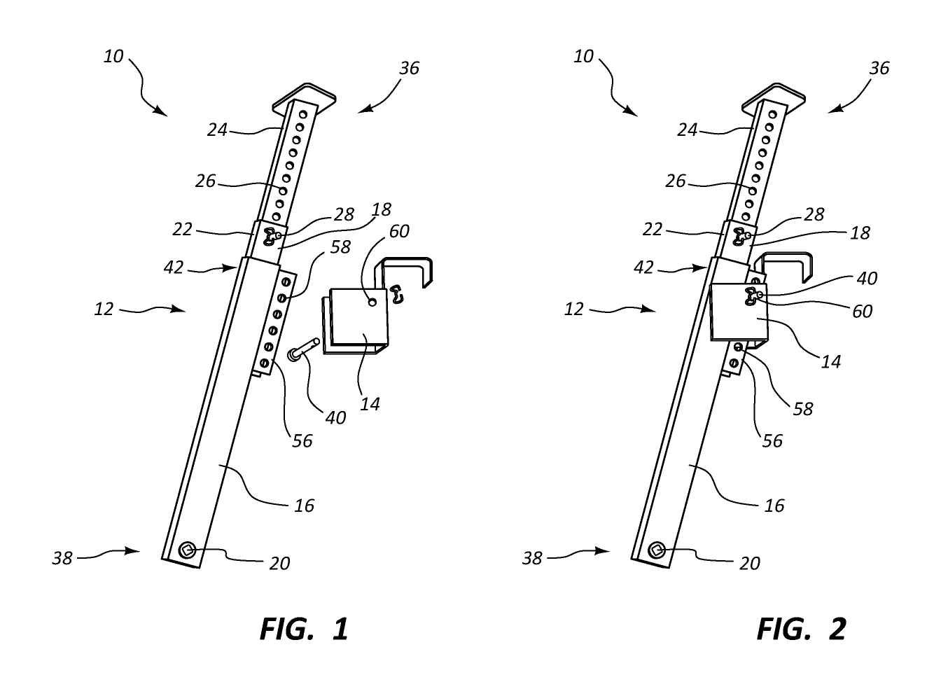

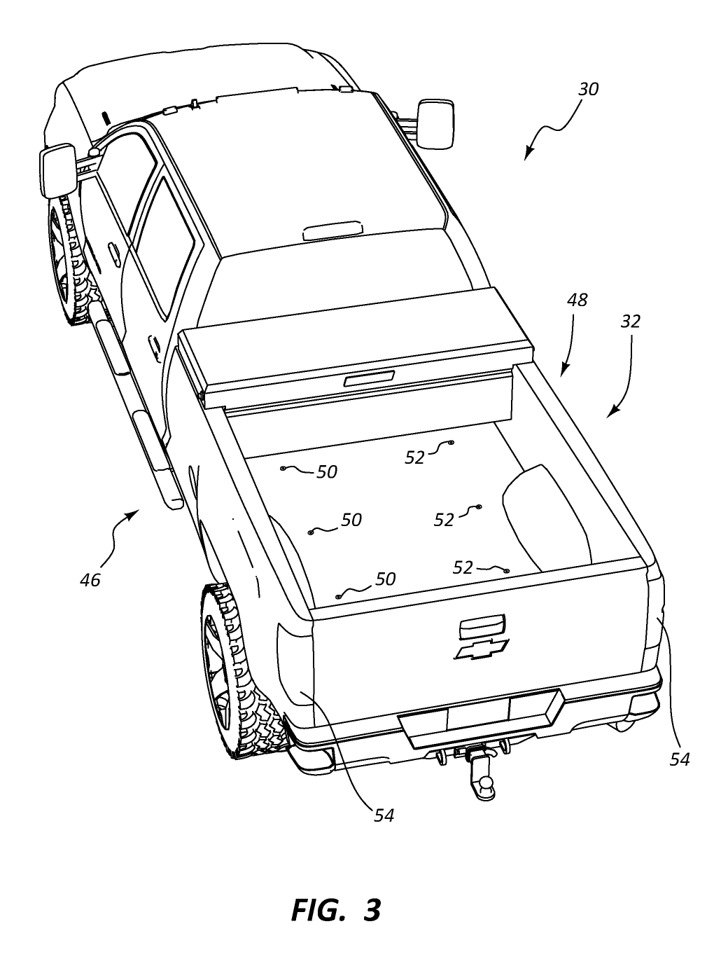

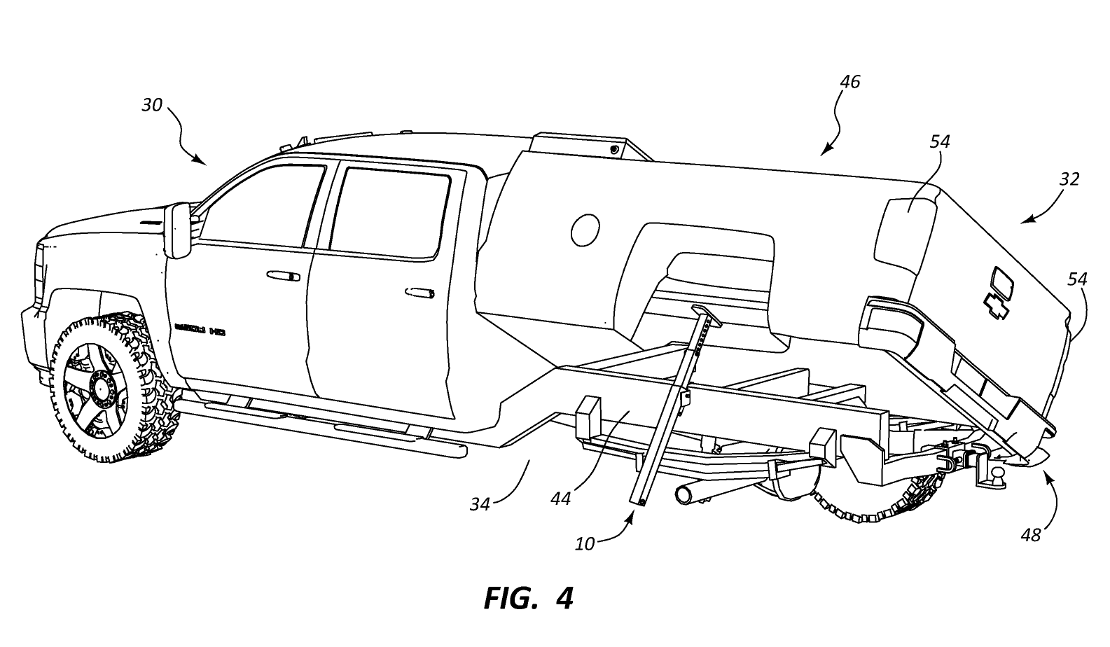

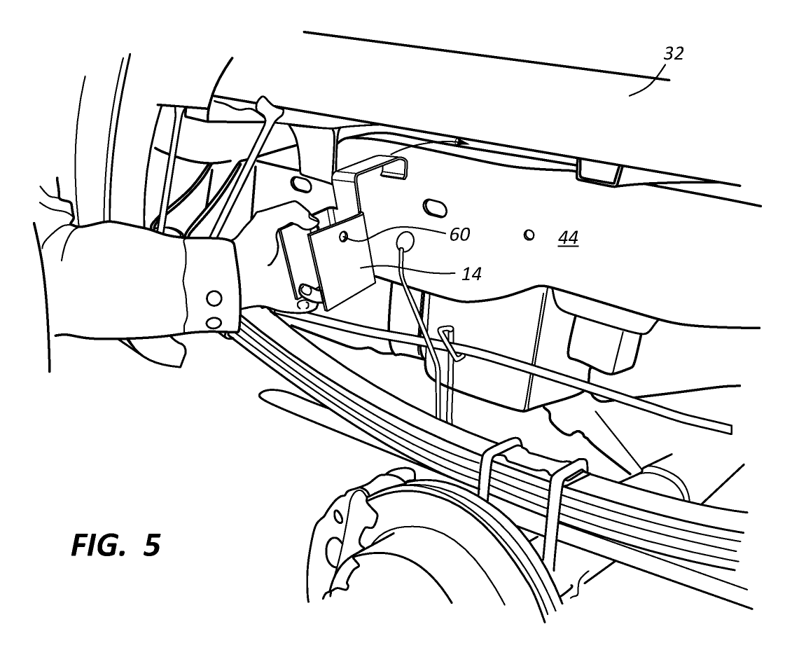

A lifting device 10 can be used to lift a bed 32 of a truck 30. Referring to FIGS. 1-2, the lifting device 10 includes a lifting mechanism 12 and a bracket 14. The lifting device 10 is coupled to an undercarriage 34 of the truck and positioned between the undercarriage 34 and the bed 32. The lifting device 10 moves the bed 32 between a lowered position (FIG. 3) where the bed 32 is supported by the undercarriage 34 and a raised position (FIG. 4) where at least a portion of the bed 32 is raised relative to the undercarriage 34.

The lifting device 10 can be used with any vehicle but is particularly useful with vehicles such as trucks where the bed 32 is a separate component that can be raised independently of the cab. FIGS. 2-3 show one embodiment of the truck 30 that can be used with the lifting device 10.

It should be appreciated that the lifting device 10 can be used with a variety of bed configurations. For example, the lifting device 10 can be used to lift beds that include a flatbed, a cargo box, a specialty body, or the like. Specialty bodies include service bodies, crane bodies, landscape bodies, chipper bodies, animal control bodies, line bodies, rescue or emergency service bodies, sign bodies, water service bodies, and/or welding bodies.

Referring to FIGS. 2-3, the bed 32 of the truck 30 includes a first side 46 and a second side 48 positioned opposite the first side 46. The bed 32 also includes lights 54 at the rear of the bed 32. The lights 54 can include lights such as turn signals lights, brake lights, back-up lights, fog lights, tail lights, clearance lights, and the like.

The sides 46, 48 of the bed 32 extend lengthwise in a direction that is parallel to a longitudinal axis of the truck 30. The first side 46 and the second side 48 of the bed 32 are coupled to the undercarriage 34 using fasteners 50, 52, respectively. In one embodiment, the fasteners 50, 52 includes bolts that fasten the bottom of the bed 32 to the undercarriage 34 (e.g., the frame rails 44).

The lifting device 10 can be configured to lift the bed 32 in any suitable manner. In one embodiment, the lifting device 10 is configured to lift the first side 46 of the bed 32 while the second side 48 remains supported by the undercarriage 34. This can be accomplished by removing the fasteners 50 and loosening the fasteners 52 until they are sufficiently loose to allow the second side 48 to pivot but still hold it to the undercarriage 34.

The lifting device 10 can be configured to extend any suitable distance. In one embodiment, the lifting device 10 can extend a total distance of 10 inches to 48 inches, 12 inches to 36 inches, or 15 inches to 24 inches. In another embodiment, the lifting device 10 can extend a total distance of at least 10 inches, at least 12 inches, or at least 15 inches. In another embodiment, the lifting device 10 can extend a total distance of no more than 48 inches, no more than 36 inches, or no more than 24 inches.

In one embodiment, the lifting device 10 is a portable tool used by a mechanic or other user to lift the bed of a variety of trucks. The lifting device 10 can be coupled to and removed from the truck 30 in a readily releasable manner. This is different than lifting devices used with dump trucks—i.e., trucks where the bed is intended to dump to the side or back. The lifting devices in those situations are specially designed for the truck and are permanently attached.

In another embodiment, the tool is a kit including the lifting mechanism 12 and multiple brackets 14 sized to fit the undercarriages of a variety of trucks. The brackets 14 are sized to fit over and hand on different sized frame rails—e.g., frame rails having a top width of 1.5 inches to 3.5 inches.

The lifting mechanism 12 includes a fixed member 16 and a movable member 18. The fixed member 16 is coupled to the bracket 14. The movable member 18 is coupled to the fixed member 16 in a manner that allows the movable member 18 to extend and retract relative to the fixed member 16. In one embodiment, the lifting mechanism 12 includes a drive mechanism that extends and retracts the movable member 18 relative to the fixed member 16.

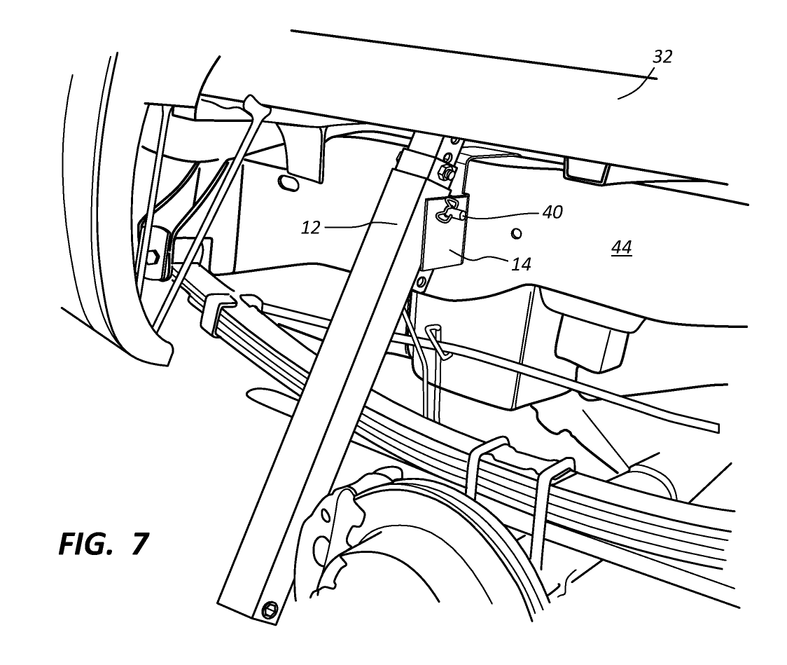

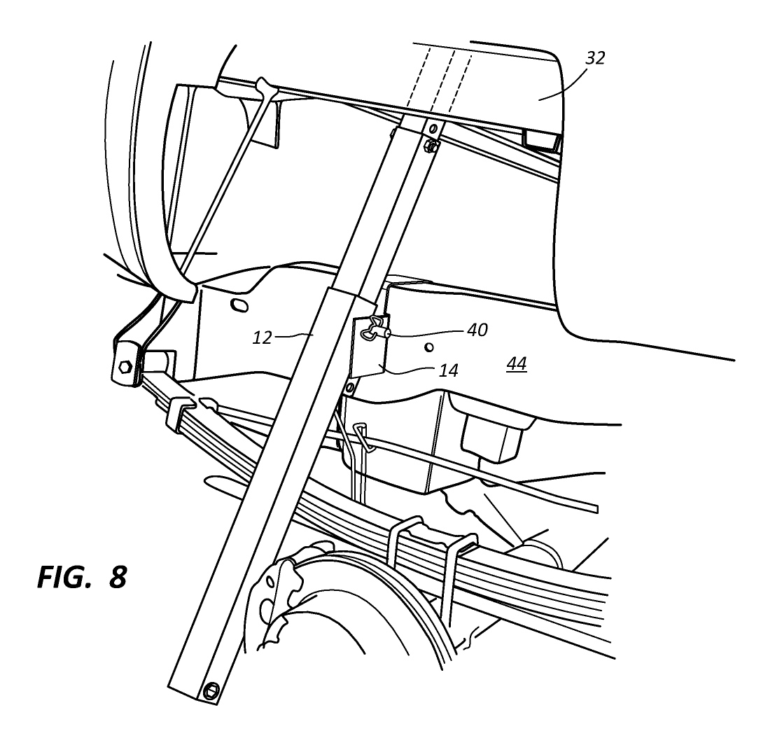

The lifting mechanism 12 moves between an extended position where the movable member 18 is extended outward from the fixed member 16 and a retracted position where the movable member 18 is retracted toward the fixed member. Referring to FIGS. 7-8, the lifting mechanism 12 moves between a retracted position (FIG. 7) where the bed 32 is supported by the undercarriage 34 and an extended position (FIG. 8) where at least a portion of the bed 32 is raised relative to the undercarriage 34.

The lifting mechanism 12 includes a first end 36 configured to contact the underside of the bed 32 and a second end 38 positioned opposite the first end 36. The first end 36 extends generally upward during use and the second end 38 extends generally downward.

The lifting mechanism 12 can have any suitable size and shape. In one embodiment, the fixed member 16 and the movable member 18 are tubes that telescope relative to each other. For example, the movable member 18 can have a smaller cross-sectional size than the fixed member 16 so that it can telescope in and out of the fixed member 16. The members 16, 18 can have any suitable cross-sectional shape such as square, round, rectangular, triangular, and the like.

The fixed member 16 houses the drive mechanism of the lifting mechanism 12. The fixed member 16 includes a first end 42 and a second end 38. The first end 42 is oriented upward and positioned closer to the underside of the bed 32 during use than the second end 38. The movable member 18 extends and retracts from the first end 42. It should be noted that in the embodiment shown in FIGS. 1-2 the second end 38 is the same for the lifting mechanism 12 and the fixed member 16 so the same reference numeral is used to refer to both.

The fixed member 16 can have any suitable configuration. In one embodiment, the fixed member 16 is a square tube (e.g., 2 inches square). In another embodiment, the fixed member 16 is a round tube. In yet another embodiment, the fixed member 16 is a C-shape channel. Numerous other possibilities are contemplated as well.

The fixed member 16 includes a mounting bracket 56 located adjacent to the first end 42. The mounting bracket 56 is used to couple the lifting mechanism 12 to the bracket 14. The mounting bracket 56 can have any of a number of configurations. In one embodiment, the mounting bracket 56 is configured to allow the position of the bracket 14 to be adjusted lengthwise along the fixed member 16.

Referring to FIGS. 1-2, in one embodiment, the mounting bracket 56 includes multiple holes 58 to which the bracket 14 can be coupled. The position of the bracket 14 can be adjusted by coupling it to higher or lower hole 58.

The movable member 18 extends from and retracts towards the fixed member 16. The movable member 18 includes a first end 36 and a second end (not shown) positioned inside the fixed member 16. The first end 36 is the same for the lifting mechanism 12 and the movable member 18 so the same reference numeral is used to refer to both.

The movable member 18 can have any suitable configuration. In one embodiment, the movable member 18 is a square tube sized slightly smaller than the fixed member 16 to allow the movable member 18 to extend and retract from the fixed member 16. In another embodiment, the movable member 18 is a round tube. In yet another embodiment, the movable member 18 is a rail that extends from a C-shaped channel. Numerous other possibilities are contemplated as well.

The first end 36 can include a structure that provides a stable surface to contact the underside of the bed 32. In one embodiment, the movable member 18 includes a base 62 at the first end 36. The base 62 is configured to contact the underside of the bed 32 and distribute the weight of the bed 32 across a large surface area. In one embodiment, the base 62 has a rectangular shape with one dimension being relatively narrow to allow the base 62 to fit between the edge of the wheel well and the frame rail (FIG. 7).

The length of the movable member 18 can be adjusted separately from the drive mechanism. This can be accomplished in a variety of ways. In one embodiment, the movable member 18 includes a first or main member 22 coupled to a second or auxiliary member 24 in a manner that allows the auxiliary member 24 to extend and retract relative to the main member 22.

In one embodiment, the main member 22 and the auxiliary member 24 are tubes that telescope relative to each other. For example, the auxiliary member 24 can have a smaller cross-sectional size than the main member 22 so that it can telescope in and out of the main member 22.

The members 22, 24 can be coupled together in any suitable manner. In one embodiment, the main member 22 includes a hole near the end that receives the auxiliary member 24. A fastener 28 extends through the hole in the main member 22 and one of a plurality of corresponding holes 26 in the auxiliary member 24 to couple the members 22, 24 together. The fastener 28 can be released in any suitable manner. In one embodiment, the fastener 28 can be readily released.

The movable member 18 can increase the total distance the lifting device 10 can extend by any suitable amount. In one embodiment, the movable member 18 can extend any of the distances described above in connection with the lifting device 10. In other words, the drive mechanism can extend the lifting device 10 any of the distances described above and the movable member 18 can extend the lifting device 10 an additional amount equal to any of the distances given above. In this manner, the movable member 18 can increase the total distance the lifting device 10 can extend by any amount up to double the distances given above.

In one embodiment, the movable member 18 is coupled to the fixed member 16 with a screw mechanism. The screw mechanism includes a screw positioned in the fixed member 16 and a nut coupled to the movable member 18. The screw rotates freely inside the fixed member 16 to move the nut lengthwise along the screw, which causes the movable member 18 to extend and retract relative to the fixed member 16.

The lifting device 10 can include any suitable screw mechanism. In one embodiment, the lifting device 10 includes an acme screw mechanism. In another embodiment, the lifting device 10 includes a ball screw mechanism.

The screw mechanism is actuated using one or more drive members 20 accessible on the outside of the fixed member 16. In one embodiment, the lifting device 10 includes multiple drive members 20 accessible on the exterior of the fixed member 16. For example, one drive member 20 can be positioned on one side of the fixed member 16 and another drive member 20 can be positioned on an opposite side of the fixed member 16. This configuration allows the user to operate the lifting device 10 from either side.

The drive member 20 can have any of a number of configurations. For example, the drive member 20 can include a recess and/or a projection configured to correspond to a handle, drive shaft, or other actuator device. In one embodiment, the drive member 20 is configured to be coupled to a handle. The user extends and retracts the lifting device 10 by rotating the handle. In another embodiment, the drive member 20 is configured to be coupled to a power tool such as an impact wrench. The power tool can be powered by air, electricity, and the like. The user extends and retracts the lifting device 10 with the power tool.

It should be appreciated that the lifting device 10 can use other types of drive mechanisms to extend and retract the movable member 18. For example, the lifting device 10 can include a hydraulic lifting mechanism that extends and retracts the movable member. The user can operate the hydraulic mechanism with a hand operated pump.

The bracket 14 is configured to be coupled to the undercarriage 34 of the truck 30. The undercarriage 34 includes any of the components underneath the bed 32. The bracket 14 can be coupled to any of the components that make up the undercarriage 34. For example, the bracket 14 can be coupled to the a chassis, a frame, or, preferably, a frame rail 44 of the truck 30.

The bracket 14 can be coupled to the undercarriage 34 in any suitable manner. In one embodiment, the bracket 14 is coupled to the undercarriage 34 without using any fasteners. For example, the bracket 14 can be configured to hang on the frame rail 44. This makes it easy to couple the bracket 14 to the undercarriage 34 and remove it when it is no longer needed.

The lifting mechanism 12 can be coupled to the bracket 14 in any suitable manner. In one embodiment, the lifting mechanism 12 is pivotably coupled to the bracket 14. This allows the lifting mechanism 12 to pivot relative to the bracket 14 as the bed 32 moves between the lowered position and the raised position. In another embodiment, the lifting mechanism 12 can be coupled to the bracket 14 in a readily releasable manner.

In another embodiment, the lifting mechanism 12 is coupled to the bracket 14 using a fastener 40 that extends through a hole 60 in the bracket 14 and one of the holes 58 in the mounting bracket 56 (FIG. 2). The fastener 40 can provide a pivot axis for the lifting mechanism 12 as it rotates relative to the bracket 14. The fastener 40 can include any suitable fastener such as a pivot pin or the like. The fastener 40 can be a releasable fastener that is releasable in any suitable manner. For example, the fastener 28 can be easily or readily released.

Referring to FIG. 2, the lifting mechanism 12 and the bracket 14 are configured so that the bracket 14 is positioned to the side of the lifting mechanism 12 in a manner that allows the lifting mechanism 12 to slant upwards toward the bracket 14. There is enough space between the lifting mechanism 12 and the bracket 14 to allow the lifting mechanism 12 to slant at least 3°, at least 5°, at least 7.5°, or at least 10° towards the bracket 14.

In this configuration, the lifting mechanism 12 extends downward below the frame rail and into a wheel well area of the truck 30. The lifting mechanism 12 is positioned on the outside of the frame rail of the truck 30 (FIG. 7). The slanted orientation of the lifting mechanism 12 makes it so the first end 36 can reach the area on the underside of the bed 32 that is just inside the fender or wheel well. It should be appreciated that it is the lifting mechanism 12 can operate without being slanted depending on the configuration of the underside of the bed 32.

The bracket 14 can be coupled to the lifting mechanism 12 at any suitable location. In one embodiment, the bracket 14 is coupled to the lifting mechanism 12 at an intermediate location between the ends 36, 38. Any location that is not on the ends 36, 38 is considered an intermediate location.

The lifting mechanism 12 can be coupled to the bracket 14 at a location that is a first distance from the second end 38 of the lifting mechanism 12. In the embodiment shown in FIGS. 1-2, the first distance is the distance from the fastener 40 to the second end 38 of the lifting mechanism 12. In general, it is preferable to couple the bracket 14 near the first end 42 of the fixed member 16.

In one embodiment, the first distance is at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least or 80% of (a) the total length of the lifting mechanism 12 when the lifting mechanism 12 is in the retracted position or (b) the total length of the fixed member 16. The first distance can be anywhere from 5% to 95% of (a) or (b). Preferably, the first distance is at least half of (a) or (b).

In another embodiment, the first distance is at least 1 inch, at least 2 inches, at least 3 inches, at least 4 inches, at least 5 inches, at least 6 inches, at least 7 inches, at least 8 inches, at least 9 inches, at least 10 inches, at least 11 inches, at least 12 inches, at least 13 inches, at least 14 inches, at least 15 inches, at least 16 inches, at least 17 inches, at least 18 inches, at least 19 inches, at least 20 inches, at least 21 inches, at least 22 inches, at least 23 inches, or at least 24 inches. The first distance can be anything from 1 inch to 24 inches.

It should be appreciated that the bracket 14 can have a number of alternative configurations. For example, the bracket 14 can be an OEM component of the undercarriage 34 supplied by the vehicle manufacturer. The manufacturer can bolt, weld or otherwise fasten the bracket 14 to the undercarriage 34 as part of the manufacturing process.

A variety of methods can be used to lift the bed 32 of the truck 30. FIGS. 5-8 show one embodiment of a method for lifting the bed 32. The first step is to remove the tire or wheel under the first side 46 of the bed 32 to allow better access to the underside of the bed 32 (or remove multiple wheels if the vehicle is a dually or otherwise has multiple wheels and/or axles). The second step is to remove the fasteners 50 coupling the first side 46 of the bed 32 to the undercarriage 34. The third step is to loosen the fasteners 52 coupling the second side 48 of the bed 32 to the undercarriage. The fasteners 52 are not removed and remain loosely fastened to allow the bed 32 to pivot or rotate along an axis formed by the fasteners 52.

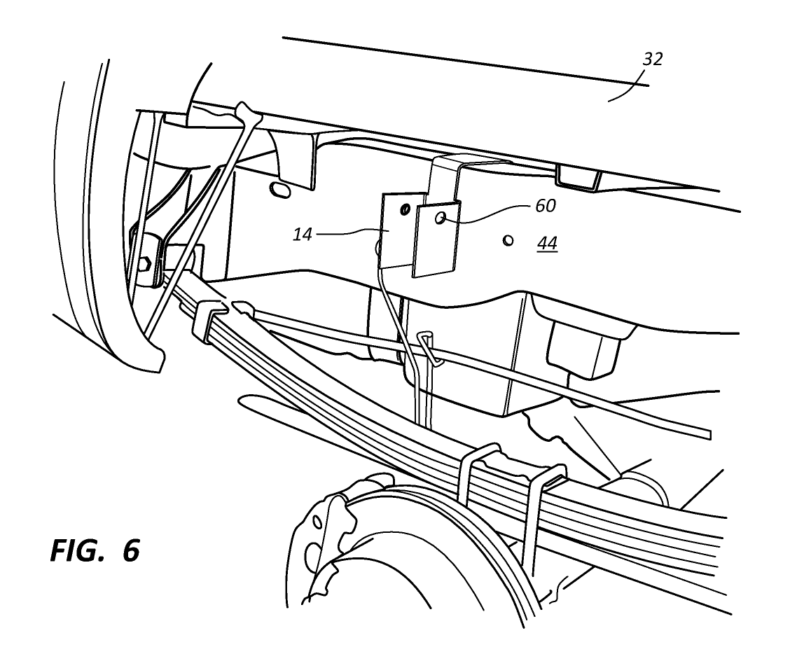

The fourth step is to disconnect the lights 54 on the first side of the bed 32. The fifth step is to position the lifting device 10 between the bed 32 and the undercarriage 34 of the truck 30. This can be done in any of the ways described above. In one embodiment, the bracket 14 is coupled to the undercarriage 34 in the manner shown in FIGS. 5-6. The lifting mechanism 12 is then coupled to the bracket 14 in the manner shown in FIG. 7.

The lifting mechanism 12 is slanted upward towards the bracket 14 to reach the area under the bed 32 that is just inside the wheel well or fender. This area provides a better surface to use to lift the bed 32 than the area in the fender or wheel well. The fifth step is to operate the lifting device 10 to lift the first side 46 of the bed 32 in the manner shown in FIGS. 4 and 8.

With the bed 32 raised, the user can now perform any required maintenance or other necessary task in the area under the bed 32. Specifically, the user can replace a defective fuel pump, change a fuel level sensor, etc. This method of lifting the bed 32 makes this process much easier.

The above steps are reversed to lower the bed 32 and return the truck 30 to its original condition. It should be appreciated that the method can be modified in any of a number of ways. For example, the number of the steps can be altered so that the method includes less steps or additional steps—i.e., the wheel can be left on the truck 30. Also the order of the steps can be altered so that the steps can be performed in any order so long as a later step isn't dependent on earlier step being performed.

It should also be appreciated that the method can use any suitable device to lift the bed 32 and the lifting device 10 is but one example of such a device.

### Illustrative Embodiments

Reference is made in the following to a number of illustrative embodiments of the disclosed subject matter. The following embodiments illustrate only a few selected embodiments that may include one or more of the various features, characteristics, and advantages of the disclosed subject matter. Accordingly, the following embodiments should not be considered as being comprehensive of all of the possible embodiments.

It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

In one embodiment, a lifting device for lifting a bed of a truck comprises: a bracket configured to be coupled to an undercarriage of the truck; and a lifting mechanism coupled to the bracket, the lifting mechanism being configured to extend from the bracket to the underside of the bed; wherein the lifting mechanism is configured to move between a retracted position where the bed is supported by the undercarriage and an extended position where at least a portion of the bed is raised relative to the undercarriage; and wherein the bracket is coupled to the lifting mechanism at an intermediate location on the lifting mechanism.

The lifting device can include a first end configured to contact the underside of the bed and a second end positioned opposite the first end, and wherein the lifting mechanism can be coupled to the bracket at a location that is at least a first distance from the second end, the first distance being at least 5% of the total length of the lifting mechanism when the lifting mechanism is in the retracted position.

The first distance can be at least 10%, 15%, 20%, 25%, 30%, 35%, 40%, 45%, 50%, 55%, 60%, 65%, 70%, 75%, or 80% of the total length of the lifting mechanism when the lifting mechanism is in the retracted position. The first distance can be 10% to 95% of the total length of the lifting mechanism when the lifting mechanism is in the retracted position. The first distance can be at least half of the total length of the lifting mechanism when the lifting mechanism is in the retracted position.

The lifting mechanism can include a first end configured to contact the underside of the bed and a second end positioned opposite the first end, and wherein the lifting mechanism is coupled to the bracket at a location that is at least 1 inch, 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, or 24 inches from the second end. The lifting mechanism can be coupled to the bracket at a location that is 1 inch to 24 inches from the second end.

The lifting mechanism can comprise: a fixed member coupled to the bracket, the fixed member including a first end and a second end, the first end being positioned closer to the underside of the bed than the second end; and a movable member coupled to the fixed member, the movable member extending from the fixed member as the lifting mechanism moves from the retracted position to the extended position and the movable member retracting toward the fixed member as the lifting mechanism moves from the extended position to the retracted position; wherein the fixed member is coupled to the bracket at a location that is at least a first distance from the second end, the first distance being at least 5% of the length of the fixed member.

The first distance can be at least 10%, 15%, 20%, 25%, 30%, 35%, 40%, 45%, 50%, 55%, 60%, 65%, 70%, 75%, or 80% of the length of the fixed member. The first distance can be 10% to 95% of the length of the fixed member. The first distance can be at least half of the length of the fixed member. The first distance can be at least 1 inch, 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, or 24 inches from the second end of the fixed member. The lifting mechanism can be coupled to the bracket at a location that is 1 inch to 24 inches from the second end of the fixed member.

The bracket can be configured to be coupled to a chassis of the truck. The bracket can be configured to be coupled to a frame of the truck. The bracket can be configured to be coupled to a frame rail of the truck. The bed can include a flatbed, cargo box, or specialty body. The lifting mechanism can include a screw lifting mechanism. The lifting mechanism can be pivotably coupled to the bracket. The lifting mechanism can be coupled to the bracket in a readily releasable manner.

The lifting mechanism can include a fixed member coupled to the bracket and a movable member coupled to the fixed member, and wherein the movable member extends from the fixed member as the lifting mechanism moves to the extended position and the movable member retracts toward the fixed member as the lifting mechanism moves to the retracted position. The lifting mechanism can include a fixed member coupled to the bracket and a movable member coupled to the fixed member, and wherein the length of the movable member is adjustable.

In another embodiment, a lifting device for lifting a bed of a truck comprises: a bracket configured to be coupled to an undercarriage of the truck; and a lifting mechanism coupled to the bracket, the lifting mechanism being configured to extend from the bracket to the underside of the bed; wherein the lifting mechanism is configured to move between a retracted position where the bed is supported by the undercarriage and an extended position where at least a portion of the bed is raised relative to the undercarriage; and wherein the bracket is positioned to the side of the lifting mechanism when the bracket is coupled to the undercarriage and the lifting mechanism slants upward toward the bracket. The lifting mechanism can be slanted at least 3°, 5°, 7.5°, or 10° towards the bracket.

The lifting device can be configured to be coupled to a frame rail that extends parallel to a longitudinal axis of the truck with the lifting mechanism being positioned outside of the frame rail and slanting upward toward the center of the truck. The bracket can be configured to be coupled to a chassis of the truck. The bracket can be configured to be coupled to a frame of the truck. The bracket can be configured to be coupled to a frame rail of the truck.

The bed can include a flatbed, cargo box, or specialty body. The lifting mechanism can include a screw lifting mechanism. The lifting mechanism can be pivotably coupled to the bracket. The lifting mechanism can be coupled to the bracket in a readily releasable manner.

The lifting mechanism can include a fixed member coupled to the bracket and a movable member coupled to the fixed member, and wherein the movable member extends from the fixed member as the lifting mechanism moves to the extended position and the movable member retracts toward the fixed member as the lifting mechanism moves to the retracted position. The lifting mechanism can include a fixed member coupled to the bracket and a movable member coupled to the fixed member, and wherein the length of the movable member is adjustable.

In another embodiment, a lifting device for lifting a bed of a truck comprises: a bracket configured to be coupled to a frame rail of the truck that extends parallel to a longitudinal axis of the truck; and a lifting mechanism coupled to the bracket, the lifting mechanism being configured to be positioned on the outside of the frame rail and extend upward from the bracket to the underside of the bed when the bracket is coupled to the frame rail; wherein the lifting mechanism is configured to move between a retracted position where the bed is supported by the undercarriage and an extended position where at least a portion of the bed is raised relative to the undercarriage.

The lifting mechanism can be configured to be positioned in a wheel well of the truck when the bracket is coupled to the frame rail. The lifting mechanism can be configured to extend below the frame rail when the bracket is coupled to the frame rail. The lifting mechanism can be configured to slant upward toward the center of the truck.

The bed can include a flatbed, cargo box, or specialty body. The lifting mechanism can include a screw lifting mechanism. The lifting mechanism can be pivotably coupled to the bracket. The lifting mechanism can be coupled to the bracket in a readily releasable manner.

The lifting mechanism can include a fixed member coupled to the bracket and a movable member coupled to the fixed member, and wherein the movable member extends from the fixed member as the lifting mechanism moves to the extended position and the movable member retracts toward the fixed member as the lifting mechanism moves to the retracted position. The lifting mechanism can include a fixed member coupled to the bracket and a movable member coupled to the fixed member, and wherein the length of the movable member is adjustable.

In another embodiment, a lifting device kit for lifting the beds of different trucks comprises: a plurality of brackets each of which is configured to be coupled to different sized frame rails of the trucks; and a lifting mechanism configured to be coupled to each of the plurality of brackets, the lifting mechanism being configured to extend from each of the plurality of brackets to the underside of the beds of the trucks; wherein the lifting mechanism is configured to move between a retracted position where the beds are supported by the frame rails and an extended position where at least a portion of the bed is raised relative to the frame rails.

The plurality of brackets can be configured to hang from the different sized frame rails of the trucks. The beds of the different trucks can include a flatbed, cargo box, or specialty body. The lifting mechanism can include a screw lifting mechanism. The lifting mechanism can be configured to be pivotably coupled to the plurality of brackets. The lifting mechanism can be configured to be coupled to the plurality of brackets in a readily releasable manner.

The lifting mechanism can include a fixed member configured to be coupled to the plurality of brackets and a movable member coupled to the fixed member, and wherein the movable member extends from the fixed member as the lifting mechanism moves to the extended position and the movable member retracts toward the fixed member as the lifting mechanism moves to the retracted position. The lifting mechanism can include a fixed member configured to be coupled to the plurality of brackets and a movable member coupled to the fixed member, and wherein the length of the movable member is adjustable.

In another embodiment, a truck comprises: an undercarriage; a bed coupled to the undercarriage; a lifting device comprising: a bracket coupled to the undercarriage; and a lifting mechanism coupled to the bracket, the lifting mechanism extending upward from the bracket to the underside of the bed; wherein the lifting device moves the bed between a lowered position where the bed is supported by the undercarriage and a raised position where at least a portion of the bed is raised relative to the undercarriage; and wherein the bracket is coupled to the undercarriage in a readily releasable manner.

The bracket may not be fastened to the undercarriage. The undercarriage can include a frame rail that extends parallel to a longitudinal axis of the truck, and wherein the bracket is coupled to the frame rail in a readily releasable manner. The bracket can hang on the frame rail without being fastened to the frame rail. The lifting mechanism may not be fastened to the underside of the bed. The lifting mechanism can be coupled to the bracket in a readily releasable manner.

The undercarriage can include a chassis and the bracket is coupled to the chassis. The undercarriage can include a frame and the bracket is coupled to the frame. The undercarriage can include a frame rail and the bracket is coupled to the frame rail. The bed can include a flatbed, cargo box, or specialty body. The lifting mechanism can include a screw lifting mechanism. The lifting mechanism can be pivotably coupled to the bracket.

The lifting mechanism can include a fixed member coupled to the bracket and a movable member coupled to the fixed member, and wherein the movable member extends from the fixed member as the lifting device moves the bed to the raised position and the movable member retracts toward the fixed member as the lifting device moves the bed to the lowered position. The lifting mechanism can include a fixed member coupled to the bracket and a movable member coupled to the fixed member, and wherein the length of the movable member is adjustable.

In another embodiment, a truck comprises: an undercarriage; a bed coupled to the undercarriage; a lifting device comprising: a bracket coupled to the undercarriage; and a lifting mechanism coupled to the bracket, the lifting mechanism extending upward from the bracket to the underside of the bed; wherein the lifting device moves the bed between a lowered position where the bed is supported by the undercarriage and a raised position where at least a portion of the bed is raised relative to the undercarriage; and wherein the lifting mechanism is slanted relative to a vertical direction when the bed is in the lowered position. The lifting mechanism can be slanted at least 3°, 5°, 7.5°, or 10° relative to the vertical direction when the bed is in the lowered position.

The undercarriage can include a frame rail that extends parallel to a longitudinal axis of the truck, and wherein the lifting mechanism is positioned outside of the frame rail and slants upward toward the center of the truck. The lifting mechanism can remain slanted as the bed moves between the lowered position and the raised position.

The undercarriage can include a chassis and the bracket is coupled to the chassis. The undercarriage can include a frame and the bracket is coupled to the frame. The undercarriage can include a frame rail and the bracket can be coupled to the frame rail. The bed can include a flatbed, cargo box, or specialty body. The lifting mechanism can include a screw lifting mechanism. The lifting mechanism can be pivotably coupled to the bracket. The lifting mechanism can be coupled to the bracket in a readily releasable manner.

The lifting mechanism can include a fixed member coupled to the bracket and a movable member coupled to the fixed member, and wherein the movable member extends from the fixed member as the lifting device moves the bed to the raised position and the movable member retracts toward the fixed member as the lifting device moves the bed to the lowered position. The lifting mechanism can include a fixed member coupled to the bracket and a movable member coupled to the fixed member, and wherein the length of the movable member is adjustable.

In another embodiment, a truck comprises: an undercarriage; a bed including a first side and a second side that are each coupled to the undercarriage with at least one fastener; a lifting device coupled to the undercarriage and positioned between the undercarriage and the bed; wherein the lifting device moves the bed between a lowered position where the bed is supported by the undercarriage and a raised position where the first side of the bed is raised relative to the undercarriage and the second side of the bed is supported by the undercarriage; and wherein the at least one fastener used to couple the second side of the bed to the undercarriage is loosely fastened when the bed is in the raised position to hold the second side of the bed to the undercarriage and allow the first side of the bed to be raised without damaging the bed.

The at least one fastener coupling the first side of the bed to the undercarriage can be removed when the bed is in the raised position. The truck can comprise lighting coupled to the first side of the bed, wherein the lighting is disconnected when the bed is in the raised position. The lighting can include taillights.

The at least one fasteners used to couple the first side of the bed and the second side of the bed to the undercarriage can be tightly fastened and prevent the bed from being raised relative to the undercarriage when the bed is in the lowered position. The at least one fasteners can include bolts. The at least one bolt used to couple the second side of the bed to the undercarriage can be loosely fastened when the bed is in the raised position. The first side and the second side of the bed can be approximately parallel to a longitudinal axis of the truck.

The undercarriage can include a chassis and the bracket is coupled to the chassis. The undercarriage can include a frame and the bracket is coupled to the frame. The undercarriage can include a frame rail and the bracket can be coupled to the frame rail. The bed can include a flatbed, cargo box, or specialty body. The lifting mechanism can include a screw lifting mechanism. The lifting mechanism can be pivotably coupled to the bracket. The lifting mechanism can be coupled to the bracket in a readily releasable manner.

The lifting mechanism can include a fixed member coupled to the bracket and a movable member coupled to the fixed member, and wherein the movable member extends from the fixed member as the lifting device moves the bed to the raised position and the movable member retracts toward the fixed member as the lifting device moves the bed to the lowered position. The lifting mechanism can include a fixed member coupled to the bracket and a movable member coupled to the fixed member, and wherein the length of the movable member is adjustable.

In another embodiment, a method for lifting a bed of a truck comprises: positioning a lifting device between an undercarriage of the truck and the bed, the bed including a first side and a second side that are each coupled to the undercarriage with at least one fastener, the lifting device including a bracket coupled to the undercarriage and a lifting mechanism extending from the bracket to the underside of the first side of the bed; loosening the at least one fastener coupling the second side of the bed to the undercarriage until the second side of the bed is loosely fastened to the undercarriage; and operating the lifting device while the second side of the bed is loosely fastened to the undercarriage to move the first side of the bed from a lowered position where the first side of the bed is supported by the undercarriage to a raised position where the first side of the bed is raised relative to the undercarriage.

The truck can include a rear wheel and the method can comprise removing the rear wheel before positioning the lifting device between the undercarriage and the bed. The truck can include a rear wheel well and the lifting device can be positioned in or adjacent to the rear wheel well. Positioning the lifting device between the undercarriage and the bed can include coupling the bracket to the undercarriage then coupling the lifting mechanism to the bracket.

The undercarriage can include a frame and positioning the lifting device between the undercarriage and the bed can include coupling the bracket to the frame. The undercarriage can include a frame rail that extends parallel to a longitudinal axis of the truck and positioning the lifting device between the undercarriage and the bed can include coupling the bracket to the frame rail.

Positioning the lifting device between the undercarriage and the bed can include coupling the bracket to the undercarriage of the truck in a readily releasable manner. Positioning the lifting device between the undercarriage and the bed can include coupling the bracket to the undercarriage of the truck without using fasteners.

The method can comprise removing the at least one fastener coupling the first side of the bed to the undercarriage. The first side and the second side of the bed extend parallel to a longitudinal axis of the bed. The bed can include lighting and the method can comprise disconnecting the lighting.

In another embodiment, a method for lifting a bed of a truck comprises: positioning a lifting device between an undercarriage of the truck and the bed, the lifting device including a bracket coupled to the undercarriage and a lifting mechanism extending from the bracket to the underside of the bed; and operating the lifting device to move the bed from a lowered position where the bed is supported by the undercarriage to a raised position where at least a portion of the bed is raised relative to the undercarriage; wherein the lifting mechanism is coupled to the bracket at an intermediate location on the lifting mechanism.

The truck can include a rear wheel and the method can comprise removing the rear wheel before positioning the lifting device between the undercarriage and the bed. The truck can include a rear wheel well and the lifting device can be positioned in or adjacent to the rear wheel well. Positioning the lifting device between the undercarriage and the bed can include coupling the bracket to the undercarriage then coupling the lifting mechanism to the bracket.

The undercarriage can include a frame and positioning the lifting device between the undercarriage and the bed can include coupling the bracket to the frame. The undercarriage can include a frame rail that extends parallel to a longitudinal axis of the truck and positioning the lifting device between the undercarriage and the bed can include coupling the bracket to the frame rail.

Positioning the lifting device between the undercarriage and the bed can include coupling the bracket to the undercarriage of the truck in a readily releasable manner. Positioning the lifting device between the undercarriage and the bed can include coupling the bracket to the undercarriage of the truck without using fasteners.

The bed can include a first side and a second side that are each coupled to the undercarriage with at least one fastener and the method can comprise loosening the at least one fastener coupling the second side of the bed to the undercarriage until the second side of the bed is loosely fastened to the undercarriage. The method can comprise removing the at least one fastener coupling the first side of the bed to the undercarriage. The first side and the second side of the bed can extend parallel to a longitudinal axis of the bed. The bed can include lighting and the method can comprise disconnecting the lighting.

The bed can include a first side and a second side and operating the lifting device can include moving the first side of the bed from the lowered position to the raised position while the second side of the bed is supported by the undercarriage. The bed can include lighting at the rear of the bed on the first side and the method can comprise disconnecting the lighting. The first side and the second side of the bed can extend parallel to a longitudinal axis of the bed.

In another embodiment, a method for lifting a bed of a truck comprises: positioning a lifting device between an undercarriage of the truck and the bed, the lifting device including a bracket coupled to the undercarriage and a lifting mechanism extending from the bracket to the underside of the bed; and operating the lifting device to move the bed from a lowered position where the bed is supported by the undercarriage to a raised position where at least a portion of the bed is raised relative to the undercarriage; wherein the lifting mechanism is positioned to the side of the bracket and slants upward toward the bracket.

The truck can include a rear wheel and the method can comprise removing the rear wheel before positioning the lifting device between the undercarriage and the bed. The truck can include a rear wheel well and the lifting device can be positioned in or adjacent to the rear wheel well. Positioning the lifting device between the undercarriage and the bed can include coupling the bracket to the undercarriage then coupling the lifting mechanism to the bracket.

The undercarriage can include a frame and positioning the lifting device between the undercarriage and the bed can include coupling the bracket to the frame. The undercarriage can include a frame rail that extends parallel to a longitudinal axis of the truck and positioning the lifting device between the undercarriage and the bed can include coupling the bracket to the frame rail.

Positioning the lifting device between the undercarriage and the bed can include coupling the bracket to the undercarriage of the truck in a readily releasable manner. Positioning the lifting device between the undercarriage and the bed can include coupling the bracket to the undercarriage of the truck without using fasteners.

The bed can include a first side and a second side that are each coupled to the undercarriage with at least one fastener and the method can comprise loosening the at least one fastener coupling the second side of the bed to the undercarriage until the second side of the bed is loosely fastened to the undercarriage. The method can comprise removing the at least one fastener coupling the first side of the bed to the undercarriage. The first side and the second side of the bed can extend parallel to a longitudinal axis of the bed. The bed can include lighting and the method can comprise disconnecting the lighting.

The bed can include a first side and a second side and operating the lifting device can include moving the first side of the bed from the lowered position to the raised position while the second side of the bed is supported by the undercarriage. The bed can include lighting at the rear of the bed on the first side and the method can comprises disconnecting the lighting. The first side and the second side of the bed can extend parallel to a longitudinal axis of the bed.

In another embodiment, a method for lifting a bed of a truck comprises: positioning a lifting device between a frame rail of the truck and the bed, the lifting device including a bracket coupled to the frame rail and a lifting mechanism positioned on the outside of the frame rail and extending from the bracket to the underside of the bed; and operating the lifting device to move the bed from a lowered position where the bed is supported by the undercarriage to a raised position where at least a portion of the bed is raised relative to the undercarriage.

The truck can include a rear wheel and the method can comprise removing the rear wheel before positioning the lifting device between the frame rail and the bed. The truck can include a rear wheel well and the lifting device can be positioned in or adjacent to the rear wheel well.

Positioning the lifting device between the frame rail and the bed can include coupling the bracket to the frame rail then coupling the lifting mechanism to the bracket. Positioning the lifting device between the frame rail and the bed can include coupling the bracket to the frame rail of the truck in a readily releasable manner. Positioning the lifting device between the frame rail and the bed can include coupling the bracket to the frame rail of the truck without using fasteners.

The bed can include a first side and a second side that are each coupled to an undercarriage of the truck with at least one fastener and the method can comprises loosening the at least one fastener coupling the second side of the bed to the undercarriage until the second side of the bed is loosely fastened to the undercarriage. The method can comprise removing the at least one fastener coupling the first side of the bed to the undercarriage.

The first side and the second side of the bed can extend parallel to a longitudinal axis of the bed. The bed can include lighting and the method can comprise disconnecting the lighting. The bed can include a first side and a second side and operating the lifting device can include moving the first side of the bed from the lowered position to the raised position while the second side of the bed is supported by an undercarriage of the truck.

The bed can include lighting at the rear of the bed on the first side and the method can comprise disconnecting the lighting. The first side and the second side of the bed can extend parallel to a longitudinal axis of the bed.

In another embodiment, a method for lifting a bed of a truck comprises: positioning a lifting device between an undercarriage of the truck and the bed, the lifting device including a bracket coupled to the undercarriage and a lifting mechanism extending from the bracket to the underside of the bed; and operating the lifting device to move the bed from a lowered position where the bed is supported by the undercarriage to a raised position where at least a portion of the bed is raised relative to the undercarriage; wherein the bracket is coupled to the undercarriage in a readily releasable manner.

The truck can include a rear wheel and the method can comprise removing the rear wheel before positioning the lifting device between the undercarriage and the bed. The truck can include a rear wheel well and the lifting device can be positioned in or adjacent to the rear wheel well.

Positioning the lifting device between the undercarriage and the bed can include coupling the bracket to the undercarriage then coupling the lifting mechanism to the bracket. The undercarriage can include a frame and positioning the lifting device between the undercarriage and the bed can include coupling the bracket to the frame.

The undercarriage can include a frame rail that extends parallel to a longitudinal axis of the truck and positioning the lifting device between the undercarriage and the bed can include coupling the bracket to the frame rail. Positioning the lifting device between the undercarriage and the bed can include coupling the bracket to the undercarriage of the truck without using fasteners.

The bed can include a first side and a second side that are each coupled to the undercarriage with at least one fastener and the method can comprise loosening the at least one fastener coupling the second side of the bed to the undercarriage until the second side of the bed is loosely fastened to the undercarriage. The method can comprise removing the at least one fastener coupling the first side of the bed to the undercarriage. The first side and the second side of the bed can extend parallel to a longitudinal axis of the bed.

The bed can include lighting and the method can comprise disconnecting the lighting. The bed can include a first side and a second side and operating the lifting device can include moving the first side of the bed from the lowered position to the raised position while the second side of the bed is supported by the undercarriage. The bed can include lighting at the rear of the bed on the first side and the method can comprise disconnecting the lighting. The first side and the second side of the bed can extend parallel to a longitudinal axis of the bed.

In another embodiment, a method for lifting a bed of a truck comprises: positioning a lifting device between an undercarriage of the truck and the bed, the lifting device including a bracket coupled to the undercarriage and a lifting mechanism extending from the bracket to the underside of the bed; and operating the lifting device to move the bed from a lowered position where the bed is supported by the undercarriage to a raised position where at least a portion of the bed is raised relative to the undercarriage; wherein the lifting mechanism is slanted relative to a vertical direction when the bed is in the lowered position.

The truck can include a rear wheel and the method can comprise removing the rear wheel before positioning the lifting device between the undercarriage and the bed. The truck can include a rear wheel well and the lifting device can be positioned in or adjacent to the rear wheel well. Positioning the lifting device between the undercarriage and the bed can include coupling the bracket to the undercarriage then coupling the lifting mechanism to the bracket.

The undercarriage includes a frame and positioning the lifting device between the undercarriage and the bed includes coupling the bracket to the frame. The undercarriage can include a frame rail that extends parallel to a longitudinal axis of the truck and positioning the lifting device between the undercarriage and the bed can include coupling the bracket to the frame rail.

Positioning the lifting device between the undercarriage and the bed can include coupling the bracket to the undercarriage of the truck in a readily releasable manner. Positioning the lifting device between the undercarriage and the bed includes coupling the bracket to the undercarriage of the truck without using fasteners.

The bed can include a first side and a second side that are each coupled to the undercarriage with at least one fastener and the method can comprise loosening the at least one fastener coupling the second side of the bed to the undercarriage until the second side of the bed is loosely fastened to the undercarriage. The method can comprise removing the at least one fastener coupling the first side of the bed to the undercarriage. The first side and the second side of the bed can extend parallel to a longitudinal axis of the bed. The bed can include lighting and the method can comprise disconnecting the lighting.

The bed can include a first side and a second side and operating the lifting device can include moving the first side of the bed from the lowered position to the raised position while the second side of the bed is supported by the undercarriage. The bed can include lighting at the rear of the bed on the first side and the method can comprise disconnecting the lighting. The method of claim 177 wherein the first side and the second side of the bed can extend parallel to a longitudinal axis of the bed.

It should be noted that for purposes of this disclosure the term “coupled” means the joining of two or more components directly or indirectly to one another. Such joining can be stationary in nature or movable in nature. Such joining can be achieved with the components and/or any additional intermediate components being integrally formed as a single unitary body with one another or with the components and/or any additional intermediate components being attached to one another.

The term “coupled” also refers to joining that is permanent in nature or releasable and/or removable in nature. Permanent joining refers to joining the components together in a manner that is not capable of being reversed or returned to the original condition. Releasable joining refers to joining the components together in a manner that is capable of being reversed or returned to the original condition.

Releasable joining can be categorized further based on the difficulty of releasing the components and/or whether the components are released as part of their ordinary operation and/or use. Readily or easily releasable joining refers to joining that can be readily, easily, and/or promptly released with little or no difficulty or effort. Difficult or hard to release joining refers to joining that is difficult, hard, or arduous to release and/or requires substantial effort to release. The joining can be released or intended to be released as part of the ordinary operation and/or use of the components or only in extraordinary situations and/or circumstances. In the latter case, the components can be intended to remain joined for a long, indefinite period until the extraordinary circumstances arise.

It should be appreciated that the components can be joined together using any type of fastening method and/or fastener. The fastening method refers to the manner in which the components are joined. A fastener is generally a separate component used to mechanically join the components together. A list of examples of fastening methods and/or fasteners are given below. The list is divided according to whether the fastening method and/or fastener is generally permanent, readily released, or difficult to release.

Examples of permanent fastening methods include welding, soldering, brazing, crimping, riveting, stapling, stitching, some types of nailing, some types of adhering, and some types of cementing. Examples of permanent fasteners include some types of nails, some types of dowel pins, most types of rivets, most types of staples, stitches, most types of structural ties, and toggle bolts.

Examples of readily releasable fastening methods include clamping, pinning, clipping, latching, clasping, buttoning, zipping, buckling, and tying. Examples of readily releasable fasteners include snap fasteners, retainer rings, circlips, split pin, linchpins, R-pins, clevis fasteners, cotter pins, latches, hook and loop fasteners (Velcro), hook and eye fasteners, push pins, clips, clasps, clamps, zip ties, zippers, buttons, buckles, split pin fasteners, and/or conformat fasteners.

Examples of difficult to release fastening methods include bolting, screwing, most types of threaded fastening, and some types of nailing. Examples of difficult to release fasteners include bolts, screws, most types of threaded fasteners, some types of nails, some types of dowel pins, a few types of rivets, a few types of structural ties.

It should be appreciated that the fastening methods and fasteners are categorized above based on their most common configurations and/or applications. The fastening methods and fasteners can fall into other categories or multiple categories depending on their specific configurations and/or applications. For example, rope, string, wire, cable, chain, and the like can be permanent, readily releasable, or difficult to release depending on the application.

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure the term shall mean,” etc.).

References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope.

The subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be given their broadest interpretation in view of the prior art and the meaning of the claim terms.

As used herein, spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

All disclosed ranges are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

All disclosed numerical values are to be understood as being variable from 0-100% in either direction and thus provide support for claims that recite such values or any and all ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range (e.g., 15.2).

1-107. (canceled)

108. A method for lifting a bed of a truck comprising:
removing a rear wheel of the truck;
positioning a lifting device between an undercarriage of the truck and the bed, the lifting device including a bracket coupled to the undercarriage and a lifting mechanism extending from the bracket to the underside of the bed; and
operating the lifting device to move the bed from a lowered position where the bed is supported by the undercarriage to a raised position where at least a portion of the bed is raised relative to the undercarriage;
wherein the lifting mechanism is coupled to the bracket at an intermediate location on the lifting mechanism.

109. (canceled)

110. The method of claim 108 wherein the truck includes a rear wheel well and the lifting device is positioned in or adjacent to the rear wheel well.

111. The method of claim 108 wherein positioning the lifting device between the undercarriage and the bed includes coupling the bracket to the undercarriage then coupling the lifting mechanism to the bracket.

112. (canceled)

113. The method of claim 108 wherein the undercarriage includes a frame rail that extends parallel to a longitudinal axis of the truck and positioning the lifting device between the undercarriage and the bed includes coupling the bracket to the frame rail.

114. The method of claim 108 wherein positioning the lifting device between the undercarriage and the bed includes coupling the bracket to the undercarriage of the truck in a readily releasable manner.

115. (canceled)

116. The method of claim 108 wherein the bed includes a first side and a second side that are each coupled to the undercarriage with at least one fastener and the method comprises:
removing the at least one fastener coupling the first side of the bed to the undercarriage;
loosening the at least one fastener coupling the second side of the bed to the undercarriage until the second side of the bed is loosely fastened to the undercarriage; and
moving the first side of the bed from the lowered position to the raised position while the second side of the bed is supported by the undercarriage.

117. (canceled)

118. The method of claim 116 wherein the first side and the second side of the bed extend parallel to a longitudinal axis of the bed.

119. The method of claim 108 wherein the bed includes lighting and the method comprises disconnecting the lighting.

120-179. (canceled)

180. A method for lifting a bed of a truck comprising:
positioning a lifting device between an undercarriage of the truck and the bed, the lifting device including a bracket coupled to the undercarriage and a lifting mechanism extending from the bracket to the underside of the bed; and
operating the lifting device to move the bed from a lowered position where the bed is supported by the undercarriage to a raised position where at least a portion of the bed is raised relative to the undercarriage;
wherein the lifting mechanism is coupled to the bracket at an intermediate location on the lifting mechanism; and
wherein the truck includes a rear wheel well and the lifting device is positioned in or adjacent to the rear wheel well.

181. The method of claim 180 wherein positioning the lifting device between the undercarriage and the bed includes coupling the bracket to the undercarriage then coupling the lifting mechanism to the bracket.

182. The method of claim 180 wherein the undercarriage includes a frame rail that extends parallel to a longitudinal axis of the truck and positioning the lifting device between the undercarriage and the bed includes coupling the bracket to the frame rail.

183. The method of claim 180 wherein positioning the lifting device between the undercarriage and the bed includes coupling the bracket to the undercarriage of the truck in a readily releasable manner.

184. The method of claim 180 wherein the bed includes a first side and a second side that are each coupled to the undercarriage with at least one fastener and the method comprises:
removing the at least one fastener coupling the first side of the bed to the undercarriage;
loosening the at least one fastener coupling the second side of the bed to the undercarriage until the second side of the bed is loosely fastened to the undercarriage; and
moving the first side of the bed from the lowered position to the raised position while the second side of the bed is supported by the undercarriage.

185. The method of claim 184 wherein the first side and the second side of the bed extend parallel to a longitudinal axis of the bed.

186. The method of claim 180 wherein the bed includes lighting and the method comprises disconnecting the lighting.

187. A method for lifting a bed of a truck comprising:
positioning a lifting device between an undercarriage of the truck and the bed, the lifting device including a bracket coupled to the undercarriage and a lifting mechanism extending from the bracket to the underside of the bed;
disconnecting lighting included with the bed; and
operating the lifting device to move the bed from a lowered position where the bed is supported by the undercarriage to a raised position where at least a portion of the bed is raised relative to the undercarriage;
wherein the lifting mechanism is coupled to the bracket at an intermediate location on the lifting mechanism.

188. The method of claim 187 wherein the truck includes a rear wheel well and the lifting device is positioned in or adjacent to the rear wheel well.

189. The method of claim 187 wherein positioning the lifting device between the undercarriage and the bed includes coupling the bracket to the undercarriage then coupling the lifting mechanism to the bracket.

190. The method of claim 187 wherein the undercarriage includes a frame rail that extends parallel to a longitudinal axis of the truck and positioning the lifting device between the undercarriage and the bed includes coupling the bracket to the frame rail.

191. The method of claim 187 wherein positioning the lifting device between the undercarriage and the bed includes coupling the bracket to the undercarriage of the truck in a readily releasable manner.

192. The method of claim 187 wherein the bed includes a first side and a second side that are each coupled to the undercarriage with at least one fastener and the method comprises:
removing the at least one fastener coupling the first side of the bed to the undercarriage;
loosening the at least one fastener coupling the second side of the bed to the undercarriage until the second side of the bed is loosely fastened to the undercarriage; and
moving the first side of the bed from the lowered position to the raised position while the second side of the bed is supported by the undercarriage.

193. The method of claim 192 wherein the first side and the second side of the bed extend parallel to a longitudinal axis of the bed.

194. The method of claim 187 wherein the bed includes a first side and a second side and operating the lifting device includes moving the first side of the bed from the lowered position to the raised position while the second side of the bed is supported by the undercarriage.

195. The method of claim 194 wherein the lighting is at the rear of the bed on the first side.

196. The method of claim 194 wherein the first side and the second side of the bed extend parallel to a longitudinal axis of the bed.
